(19) United States
(12) Patent Application Publication
(10) Pub. No.: US 2025/0319436 A1
(43) Pub. Date: Oct. 16, 2025

(54) AIRCRAFT STRUCTURE FOR REMOVAL OF IMPURITIES FROM THE ATMOSPHERE AND ASSOCIATED TOOLS AND METHODS

(71) Applicants: Tanay Jagannathan, Dubai (AE); Ahmad Fareed AlDarwish, Dubai (AE)

(72) Inventors: Tanay Jagannathan, Dubai (AE); Ahmad Fareed AlDarwish, Dubai (AE)

(21) Appl. No.: 18/865,575

(22) PCT Filed: Jun. 2, 2023
(86) PCT No.: PCT/IB2023/055695

§ 371 Date: Nov. 13, 2024

Related U.S. Application Data
(60) Provisional application No. 63/365,736, filed on Jun. 2, 2022.

(51) Int. Cl. B01D 53/62; B01D 53/82; B64C 27/26

(52) U.S. Cl. CPC B01D 53/62; B01D 53/82; B64C 27/26; B01D 2251/302; B01D 2251/304; B01D 2251/306; B01D 2251/604; B01D 2257/504; B01D 2258/06

(57) ABSTRACT

An aircraft structure for removal of impurities from the atmosphere, especially carbon dioxide, comprises a fuselage, one or more wings extending from the fuselage, and an impurity removal device attached to the fuselage. The impurity removal device includes a reacting material configured to chemically react with the impurities within a compartment configured to enable air to pass through the compartment and to substantially prevent the reacting material from exiting the compartment. A method of removing the impurities from the atmosphere with the aircraft structure is also disclosed.

### CROSS-REFERENCE TO RELATED APPLICATIONS

This application is a national phase entry under 35 U.S.C. § 371 of International Patent Application PCT/IB2023/055695, filed Jun. 2, 2023, designating the United States of America and published as International Patent Publication WO 2023/233373 A1 on Dec. 7, 2023, which claims the benefit under Article 8 of the Patent Cooperation Treaty of U.S. Patent Application Ser. No. 63/365,736, filed Jun. 2, 2022.

### TECHNICAL FIELD

Embodiments of the disclosure generally relate to aircraft structures. In particular, embodiments of the disclosure relate to aircraft structures for removing impurities from the atmosphere, and related devices and methods.

### BACKGROUND

Carbon dioxide (CO₂) in air is a major contributor to global warming and climate change. CO₂ and other pollutants trap radiation at ground level, thus stopping the Earth from cooling at night. Besides global warming, atmospheric CO₂ can promote diseases ranging from mild drowsiness to high blood pressure and respiratory disorders. As long as fossil fuels are in use, air pollution cannot be completely eliminated. Electric cars and other innovations will help to reduce this problem in the future, but the CO₂ already present in the atmosphere will continue to contribute to global warming, climate change, and diseases unless it is removed or cleaned from the atmosphere. The average CO₂ concentration in air currently is 400 ppm (0.04%). This is 47% higher than the CO₂ levels before the third industrial revolution (1960), which was 280 ppm (0.028%). Systems have been developed for effectively cleaning or scrubbing the re-circulated air in confined spaces, such as spacecraft or submarines, where the CO₂ concentration can get much higher than the average CO₂ concentration in the air and cause toxicity.

### BRIEF SUMMARY

Accordingly, in some embodiments, an aircraft structure for removal of impurities from the atmosphere is disclosed. The aircraft structure comprises a fuselage, one or more wings extending from the fuselage, and an impurity removal device attached to the fuselage. The impurity removal device includes a reacting material configured to chemically react with the impurities within a compartment configured to enable air to pass through the compartment and to substantially prevent the reacting material from exiting the compartment.

Accordingly, in additional embodiments an aircraft structure for removal of impurities from the atmosphere is disclosed. The aircraft structure comprises a substantially hollow fuselage comprising a surface defining an internal cavity and a reacting material configured to react with the impurities, at least two apertures in the surface configured to enable airflow into the cavity through a first aperture, through the device, and airflow out of the cavity through a second aperture, a porous film positioned between the at least two apertures and the internal cavity, and at least one wing extending from the substantially hollow fuselage.

Accordingly, in some embodiments, a method of removing impurities from the atmosphere is disclosed. The method comprises passing air through a compartment of an aircraft structure. The compartment of the aircraft structure contains a reacting material configured to react with impurities in the air. The impurities are removed from the air by reacting the impurities in the air with the reacting material; and the by-products of the reaction are collected in a compartment of the aircraft structure.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 shows an isometric view of an aircraft structure according to an embodiment of the present disclosure,

FIGS. 2A and 2B show methods of removing impurities from the atmosphere using an aircraft structure including a device according to embodiments of the present disclosure;

FIG. 3 shows an isometric view of an aircraft structure according to an embodiment of the present disclosure;

FIG. 4 shows a side view of an aircraft structure according to an embodiment of the present disclosure;

FIGS. 5A-SD show enlarged cross-sectional and isometric views of an aircraft structure according to embodiments of the present disclosure;

FIG. 6 shows a top view of an aircraft structure according to an embodiment of the present disclosure,

FIG. 7 shows a top view of a fuselage of the aircraft structure of FIGS. 3-6 according to an embodiment of the present disclosure;

FIG. 8 shows a front view of an aircraft structure according to an embodiment of the present disclosure, and

FIG. 9 shows an isometric view of an impurity removal device according to an embodiment of the present disclosure.

### DETAILED DESCRIPTION

The illustrations presented herein are not meant to be actual views of any particular aircraft structure or component thereof, but are merely idealized representations employed to describe illustrative embodiments. The drawings are not necessarily to scale.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear.” “left,” “right.” “fore,” “aft,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As CO₂ concentrations in the atmosphere increase the negative effects of CO₂ also increase. Developing systems for cleaning the air in the atmosphere may mitigate the negative effects of the CO₂ by reducing the amount of CO₂ in the atmosphere. CO₂ may be cleaned from industrial effluents, with a strong alkali (e.g., strong base) like sodium hydroxide (NaOH) and potassium hydroxide (KOH) or a weak alkali (e.g., weak base) like aqueous ammonia. Adsorbents such as activated carbon may also be used for removing CO₂ from effluents. Lithium hydroxide (LiOH) canisters may be used in a spacecraft to remove CO₂ from the recirculated air in the spacecraft. LiOH may also be used to absorb CO₂ from automobile exhaust. The CO₂ absorbing capacity of LiOH is greatest at higher temperatures (90-120° C.), which is similar to the temperature of vehicular exhaust. The reaction between hydroxides and carbon dioxide is exothermic in nature and causes the temperature to rise further. Commercial products like DECARBITE®, a NaOH based chemical, may be used for removing CO₂ from gas streams. NaOH spray and polyamine based solid adsorbents may be used to capture CO₂ from air on a small scale, but both these methods may be difficult to be used efficiently on a large scale.

According to embodiments described herein, an aircraft structure (e.g., aircraft, drone, unmanned vehicle, manned vehicle, quadcopter, multirotor drone) may be utilized to remove impurities from the atmosphere (e.g., ambient air). The aircraft structure includes a device for removing the impurities, such as carbon dioxide (CO₂), from the atmosphere as the aircraft structure travels through the atmosphere. The device of the aircraft structure includes a porous shell and a reacting material. The reacting material may absorb low concentrations of CO₂ present in the atmosphere. Aircraft structures including the reacting material may significantly increase the amount of CO₂ removed from the atmosphere when compared with conventional techniques, and provide a method of mitigating the harmful impacts of CO₂ in the atmosphere.

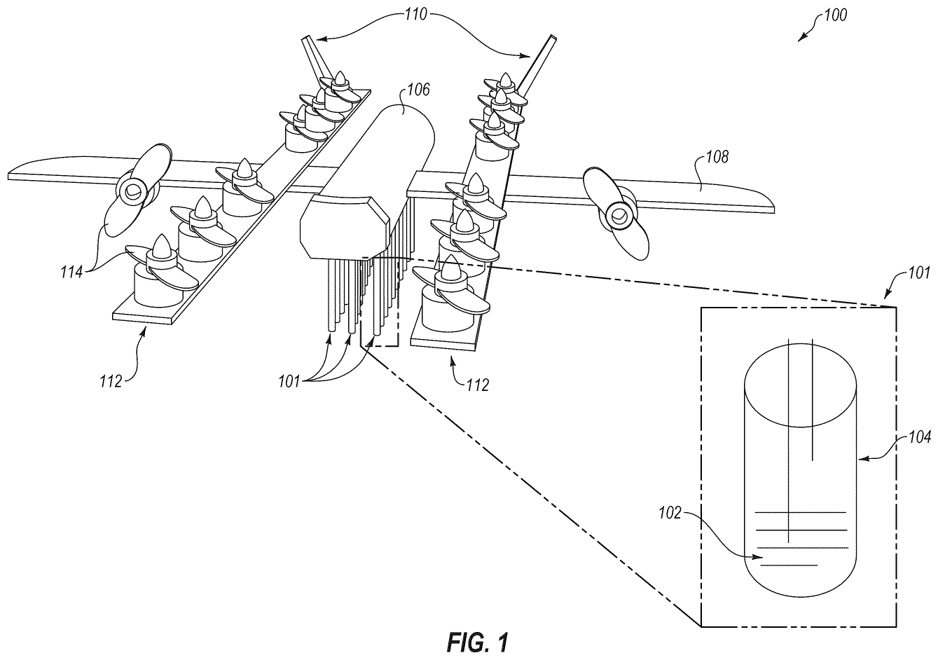

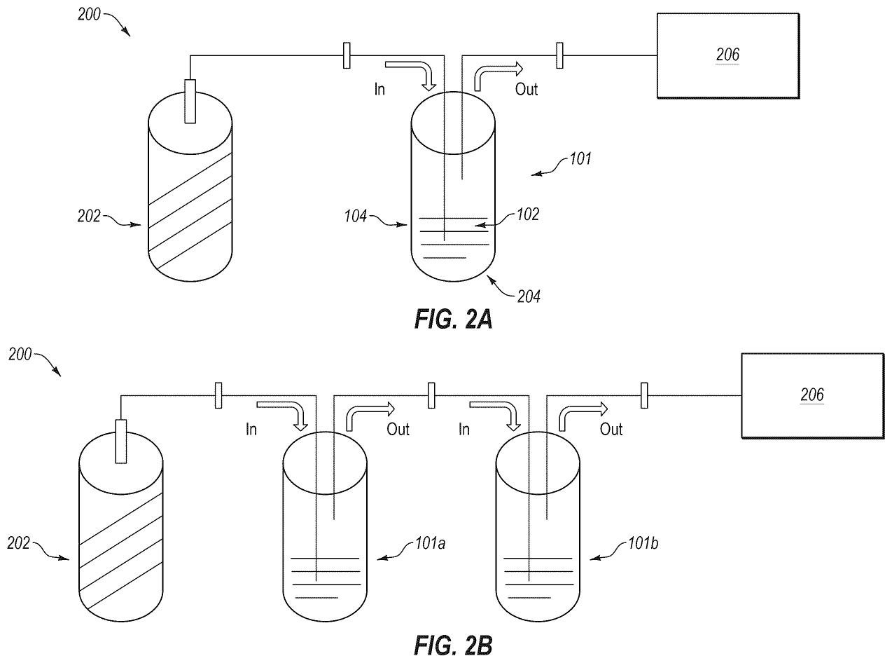

FIG. 1 shows an isometric view of an embodiment of an aircraft structure 100 including a device 101, or devices, for removing impurities. The aircraft structure 100 includes a main body 106. The main body 106 may be coupled to one or more wings 108 and one or more vertical stabilizers 110 as shown in FIG. 1. Alternatively, the aircraft structure 100 may also include one or more support structures 112 with a major axis parallel to a major axis of the main body 106. The support structures 112 and/or the wings 108 may be coupled to one or more rotors 114 with spinning blades. By way of non-limiting example, the aircraft structure may be a single rotor drone or a multirotor drone, such as a quadcopter. The aircraft structure 100 may be constructed from light weight material such as polymer materials (e.g., acrylonitrile butadiene styrene (ABS), polyethylene terephthalate glycol (PETG), polyamides (PA or Nylon), etc.), composite materials (e.g., carbon fiber, fiberglass, a polymer composite materials, etc.) or metals (e.g, aluminum, titanium, etc.). The impurity removal device 101 of the aircraft structure 100 may include a reacting material 102 configured to react with impurities, such as CO₂. The reacting material 102 may include one or more of an amine, a hydroxide, a silicate, an oxide, and other CO₂-absorbing materials. For example, the reacting material 102 may include one or more of sodium hydroxide (NaOH), potassium hydroxide (KOH), lithium hydroxide (LiOH), calcium hydroxide (Ca(OH)₂), calcium oxide (CaO), serpentinite, magnesium silicate hydroxide (Mg₃Si₂O₅(OH)₄), olivine, and others. An exemplary reaction is described below with respect to FIGS. 2A and 2B. In some embodiments, the reacting material 102 comprises NaOH.

The size and shape of the reacting material 102 of the impurity removal device 101 may be selected to increase the efficiency of CO₂ removal from the atmosphere. The reacting material 102 may be a solid material, pellets, a powder, or a liquid. Additionally, the reacting material 102 may be in impregnated form, such as fused with another material. In some embodiments, the reacting material 102 of the device 101 may be in powder form with a grain size of the powder being less than about 1000 μm, such as within a range of from about 20 nm to about 1000 nm.

In some embodiments, the material may be contained within a compartment. The compartment may be a porous shell 104, such as a porous cellulose shell, a glass microfiber shell, or a polytetrafluoroethylene (PTFE) shell (e.g., perforated PTFE), a fabric material (e.g., a woven fabric or non-woven fabric), or a perforated material. In this way, the porous shell 104 may be configured to allow air to pass through the porous shell 104 while substantially preventing the reacting material 102 from passing through the porous shell 104. The porous shell 104 may have pore sizes in the range from about 500 nm to about 15 μm, such as from about 1 μm to about 10 μm. The porous shell 104 may surround the reacting material 102 and define a shape of the impurity removal device 101. The porous shell 104 may define a relatively small shape for the impurity removal device 101, such that multiple devices 101 for removing impurities may be positioned on (e.g., over, around, within, under) the aircraft structure 100. In some embodiments, the impurity removal device is positioned inside or within the aircraft structure 100. In other embodiments, the impurity removal device is positioned outside (e.g., over, under or around) the aircraft structure. For example, the impurity removal device 101 may be a separate component from the aircraft structure 100, and may be attached to the aircraft structure 100 at various locations on or around the aircraft structure 100, as shown in FIG. 1. The impurity removal device 101 may be configured as an attachment on the aircraft structure 100. By way of non-limiting example, the aircraft structure 100 may be a commercially available drone, such as a delivery drone, a commercially available aircraft, such as an eVTOL, or other urban air mobility drone. The location of the impurity removal device 101 on the aircraft structure 100 may be defined by the location where optimal airflow occurs to promote the reaction between the reacting material 102 and the CO₂ in the atmosphere.

FIG. 2A shows a schematic 200 representative of a method of removing CO₂ using the device 101 in accordance with additional embodiments of the disclosure. During use of the aircraft structure 100, air 202 from the atmosphere enters the impurity removal device 101 through the porous shell 104. The CO₂ from the atmosphere reacts with the reacting material 102 contained in the porous shell 104 of the impurity removal device 101. The reaction that occurs between the CO₂ and the reacting material 102 may be referred to as a neutralization reaction. By way of non-limiting example, the reacting material 102 is sodium hydroxide. The following chemical reaction occurs between the CO₂ in the atmosphere and the sodium hydroxide:

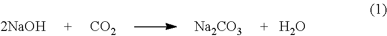

The by-products 204 of the chemical reaction in accordance with equation (1) are sodium carbonate (Na₂CO₃) and water (H₂O) While the reaction of equation (1) is exothermic, a cooling mechanism may or may not be utilized in the impurity removal device 101. The by-products 204 may remain in the porous shell 104 of the impurity removal device 101. Scrubbed air 206 exits through the pores of the porous shell 104 of the impurity removal device 101. The CO₂ concentration of the scrubbed air 206 that exits the impurity removal device 101 may be reduced. For example, the impurity removal device 101 may reduce the CO₂ concentration of the air 202 by greater than or equal to about 90%. In other embodiments, as illustrated in FIG. 2B, two or more devices 101a, 101b for removing impurities may be connected in series, where the scrubbed air 206 that exits a first impurity removal device 101a enters a second impurity removal device 101b. In the embodiment illustrated in FIG. 2B, the air 202 passes through more than one impurity removal device 101a, 101b, which may result in a greater amount of CO₂ being removed from the air 202.

The aircraft structure 100 including the impurity removal device 101 as described above and the method of using the aircraft structure 100 may have a number of advantages over conventional devices and methods. For example, the advantages may include improved impurity removal, zero (e.g., lack of) introduction of any other impurities to the atmosphere, and reduction of harmful emissions in the atmosphere. Specifically, the aircraft structure 100 according to embodiments of the disclosure may significantly improve the amount of CO₂ absorbed (e.g., scrubbed, cleaned) from the atmosphere, while also significantly improving the efficiency of CO₂ removal from the atmosphere. Additionally, Na₂CO₃ may be reused in other applications, such as treating hard water and manufacturing soaps and detergents.

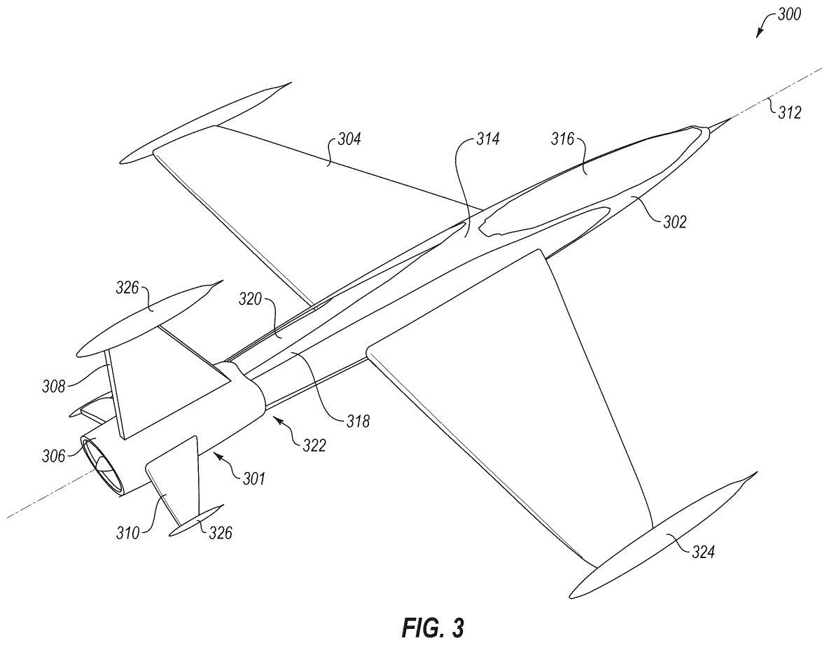

In other embodiments, an aircraft structure 300 may include an impurity removal device 301 and a fuselage 302 coupled to one or more wings 304. FIGS. 3-7 show views of the aircraft structure 300 including the impurity removal device 301. The aircraft structure 300 may also include a tail 306. The tail 306 may include a vertical stabilizer 308 and one or more horizontal stabilizers 310. The fuselage 302 may have an oblong shape extending along an axis 312. The fuselage 302 may include an outer skin 314. The outer skin 314 may define a substantially hollow portion 322 of the fuselage 302. The outer skin 314 may include one or more apertures 316, 318, 320. In some embodiments, the one or more apertures 316, 318, 320 may enable airflow to enter the substantially hollow portion 322 of the fuselage 302 through the apertures 316, 318, and 320. Another of the one or more apertures 316, 318, 320 may enable airflow to exit the substantially hollow portion 322 of the fuselage 302 through the one or more apertures 316, 318, and 320. For example, airflow may enter through a forward aperture 316 and exit through one or more aft apertures 318, 320. The aircraft structure 300 may also be constructed from light weight material such as polymer materials (e.g., acrylonitrile butadiene styrene (ABS), polyethylene terephthalate glycol (PETG), polyamides (PA or Nylon), etc.), composite materials (e.g., carbon fiber, fiberglass, a polymer composite materials, etc.) or metals (e.g., aluminum, titanium, etc.). The impurity removal device 301, similar to the impurity removal device 101 described above, with reference to FIGS. 1-2B, may be located within the substantially hollow portion 322 of the fuselage 302 of the aircraft structure 300. The airflow entering the substantially hollow portion 322 may also enter the impurity removal device 301. In some embodiments, the impurity removal device 301 may be located in other parts of the aircraft structure 300, such as in the wings 304, the tail 306, or the stabilizers 308, 310. By way of non-limiting example, the impurity removal device 301 may be located under or above the fuselage 302, or under or above the wings 304. In some embodiments, the impurity removal device 301 is located in wing tip structures 324 or stabilizer tip structures 326 positioned on a distal end of the respective wings 304 and stabilizers 308, 310.

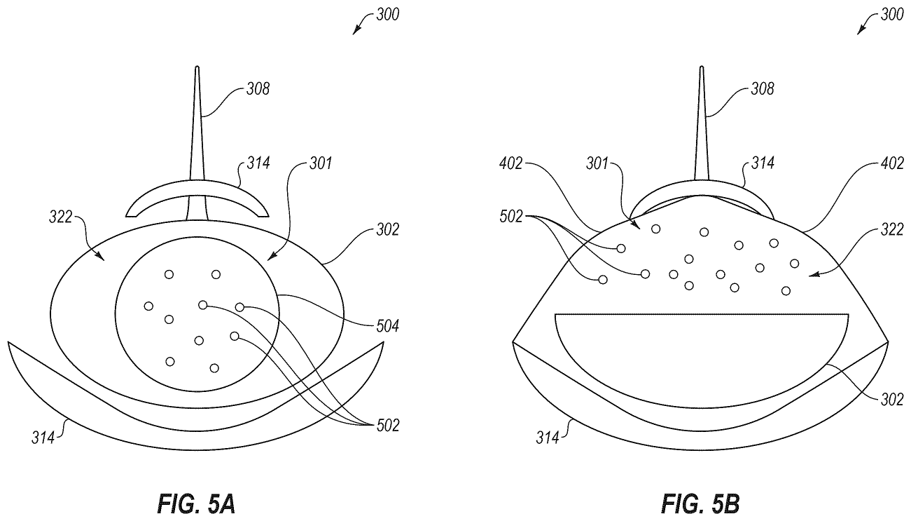

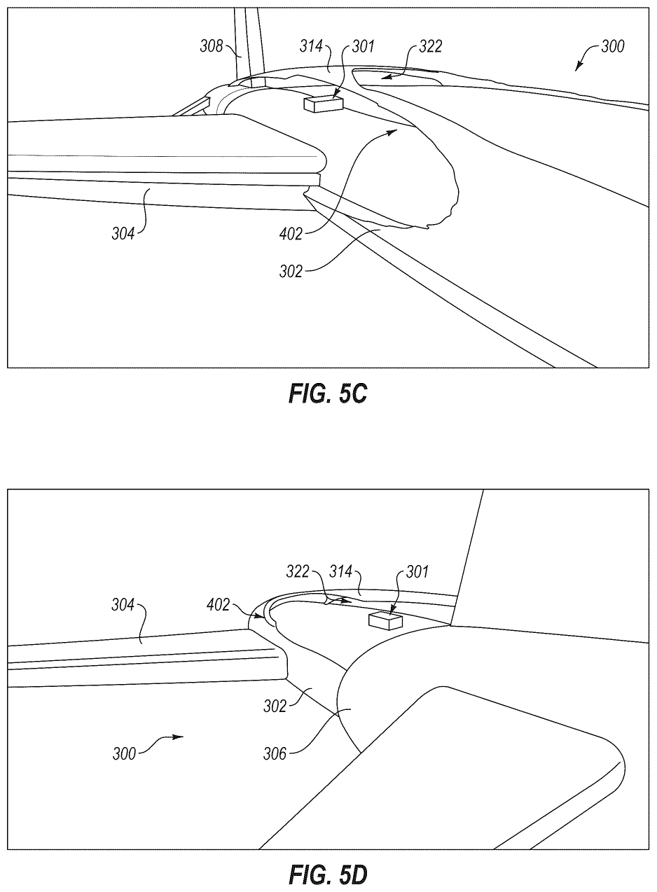

FIG. 5A illustrates an embodiment of the aircraft structure 300 including an impurity removal device 301 disposed in a hollow portion 322 of the fuselage 302. The reacting material 502 of the impurity removal device 301 may be contained within a porous shell 504, such as a porous cellulose shell, a glass microfiber shell, or a polytetrafluoroethylene (PTFE) shell, in addition, the porous shell 504 may be woven, non-woven, or perforated. In this way, the porous shell 504 may be configured to allow air to pass through the porous shell 504 while substantially preventing the reacting material 502 from passing through the porous shell 504. The porous shell 504 may have pore sizes in the range from about 500 nm to about 15 μm, such as from about 1 μm to about 10 μm. The porous shell 504 may surround the reacting material and define a shape of the impurity removal device 301. For example, the porous shell 504 may define a relatively small shape for the impurity removal device 301, such that multiple devices 301 for removing impurities may be positioned within the hollow portion 322 of the fuselage 302 or in other parts of the aircraft structure 300 as discussed above. The multiple devices 101 for removing impurities may be arranged and/or stacked within the hollow portion 322 of the fuselage 302, such that the multiple devices 301 for removing impurities may combine to substantially fill the hollow portion 322 of the fuselage 302. In another example, the porous shell 504 may define a shape of the impurity removal device 301 that is substantially the same shape as the hollow portion 322 of the fuselage 302, such that the impurity removal device 301 substantially fills the hollow portion 322 of the fuselage 302.

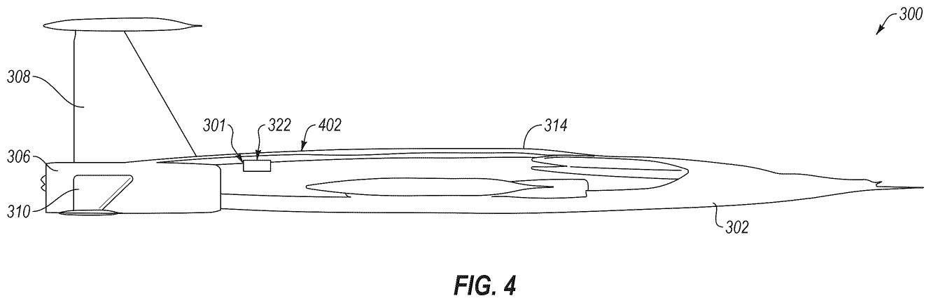

FIG. 5B illustrates another embodiment of the aircraft structure 300 including the reacting material 502 of the impurity removal device 301 positioned within the hollow portion 322 of the fuselage 302 and a porous film 402, such as a cellulose film, a glass microfiber film, or a polytetrafluoroethylene (PTFE) film may be positioned within the one or more apertures 316, 318, 320 and/or may cover the one or more apertures 316, 318, 320 shown in FIGS. 4, 5C, and 5D. The porous film 402 may have pore sizes in the range from about 500 nm to about 15 μm, such as from about 1 μm to about 10 μm, such that air may pass through the porous film 402 and the porous film 402 may substantially prevent the reacting material of the impurity removal device 301 from passing through the porous film 402. Thus, the porous film 402 may facilitate air passing through the one or more apertures 316, 318, 320 to enter and exit the hollow portion 322 of the fuselage while the reacting material of the impurity removal device 301 may be substantially prevented from passing through the porous film 402 and exiting the hollow portion 322 of the fuselage 302 through the one or more apertures 316, 318, 320.

In some embodiments, the one or more apertures 316, 318, 320 may be arranged non-uniformly about the outer skin 314 of the fuselage 302. For example, the one or more apertures 316, 318, 320 may be different sizes and/or shapes. In some embodiments, the one or more apertures 316, 318, 320 may be arranged such that no one aperture 316, 318, 320 is aligned with any other aperture 316, 318, and 320. In some embodiments, the one or more apertures 316, 318, 320 may be similar shapes but have different sizes. In some embodiments, the one or more apertures 316, 318, 320 may be similar sizes and shapes with different orientations. For example, the one or more apertures 316, 318, 320 may be substantially circular in shape, such as circular, oval shaped, ellipsis, etc. The one or more substantially circular apertures 316, 318, 320 may be oriented such that axes (e.g., minor axis, major axis, etc.) are not aligned with an adjacent aperture 316, 318, 320.

In some embodiments, the one or more apertures 316, 318, 320 may be substantially uniform and arranged in a substantially uniform pattern about a portion of the outer skin 314 of the fuselage 302. For example, one or more apertures 316, 318, 320 may be arranged about a top portion of the front portion of the fuselage 302, on the sides of the fuselage 302 where the wings 304 are attached, or both. In some embodiments, the apertures 316, 318, 320 may be multiple narrow slots axially arranged about the top portion of the front portion of the fuselage 302, on the sides of the fuselage 302 where the wings 304 are attached, or both. In some embodiments, the narrow slots may enable multiple apertures 316, 318, 320 to be arranged adjacent to one another in the same portion of the fuselage 302. In some embodiments, the apertures 316, 318, 320 may be substantially the same size, shape, etc. In some embodiments, the apertures 316, 318, 320 may have substantially the same orientation in different positions.

In some embodiments, the one or more apertures 316, 318, 320 may be arranged in the outer skin 314 of the fuselage 302 around the entire fuselage 302. In some embodiments, the one or more apertures 316, 318, 320 may only be arranged on a single side of the fuselage 302, such as the top of the fuselage 302, the bottom of the fuselage 302, front of the fuselage 302, etc.

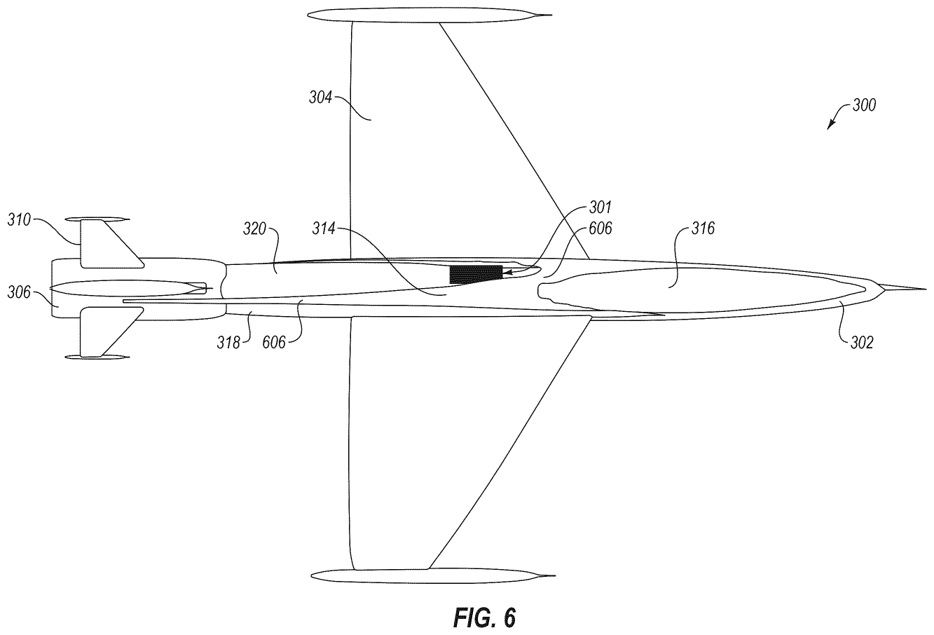

FIG. 6 shows a top view of the aircraft structure 300. The aircraft structure 300 may include multiple apertures 316, 318, 320 in the outer skin 314 of the fuselage 302. The apertures 316, 318, 320 may be non-uniform and asymmetric. For example, the apertures 316, 318, 320 may be arranged at different radial positions about the outer skin 314 of the fuselage 302. The apertures 316, 318, 320 may be defined by ribs 606 in the outer skin 314. The impurity removal device 301 may be attached to the ribs 606 in the outer skin 314 of the aircraft structure 300.

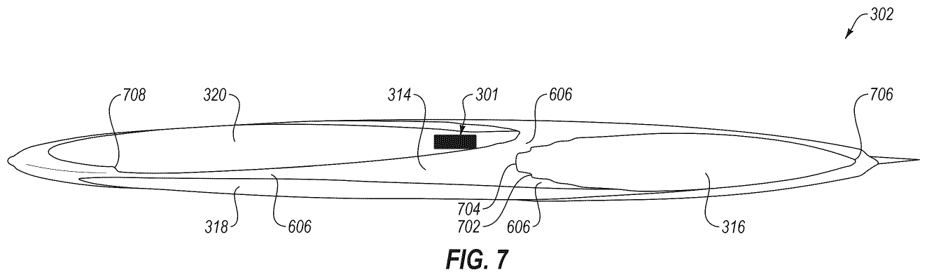

FIG. 7 shows a top view of the fuselage 302 of the aircraft structure 300. The outer skin 314 of the fuselage 302 may include ribs 606 that may define apertures 316, 318, 320 in the outer skin 314 of the fuselage 302. As shown in FIG. 7, the aperture 316, 318, 320 may be non-uniform and asymmetric. For example, the apertures 316, 318, 320 may be different sizes, shapes, etc. In some embodiments, the apertures 316, 318, 320 may be arranged in different radial and/or longitudinal positions about the fuselage 302.

As shown in FIG. 7, a first aperture 316 may be in a forward-most position on the fuselage 302. The first aperture 316 may be substantially centered on the top of the fuselage 302. A second aperture 318 and third aperture 320 may be both longitudinally and radially offset from the first aperture 316. In some embodiments, the second aperture 318 and third aperture 320 may have a different shape from the first aperture 316. For example, the second aperture 318 and third aperture 320 may be larger and longer than the first aperture 316.

In some embodiments, the first aperture 316 may have a different shape from the second aperture 318 and/or a third aperture 320. For example, the first aperture 316 may have a substantially elliptical nose portion 706 and a rear portion of the first aperture 316 may include one or more ridges 702 and a flat portion 704 in the rib 606 defining the first aperture 316. The second aperture 318 may have a substantially elliptical shape. The third aperture 320 may be substantially elliptical in shape with at least one ridge 708 in the rib 606 defining the third aperture 320. In some embodiments, the second aperture 318 and/or the third aperture 320 may include one or more ridges and/or flat portions in the associated ribs 606 defining the respective second aperture 318 and third aperture 320. For example, the second aperture 318 and the third aperture 320 may have flat portions and ridges positioned in different respective positions from those in the first aperture 316.

In some embodiments, each of the apertures 316, 318, 320 may have substantially the same size and shape, with only a position of the apertures 316, 318, 320 being different. The different positions, sizes, and shapes of the apertures 316, 318, 320 may have different effects on the airflow through the hollow portion 322 of the fuselage 302 through the one or more apertures 316, 318, and 320.

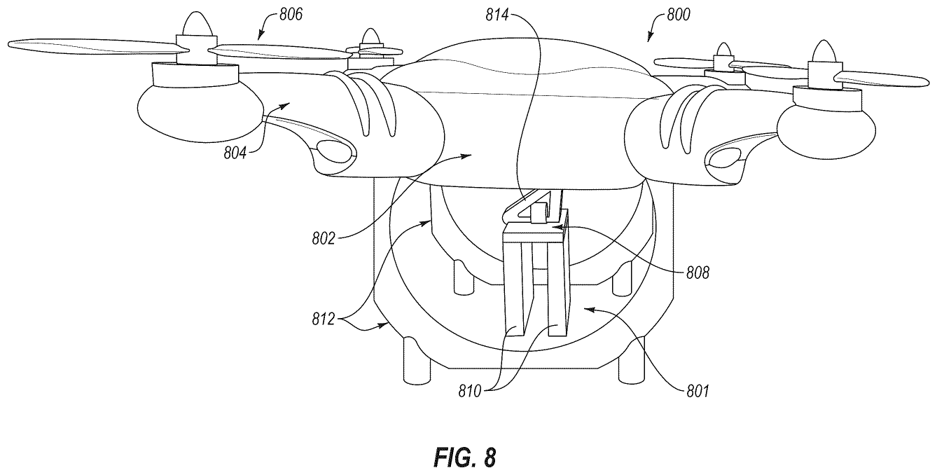

FIG. 8 shows a front view of an embodiment of an aircraft structure 800 including an impurity removal device 801. The aircraft structure 800 includes a main body 802 (e.g., fuselage, frame). The main body 802 of the aircraft structure 800 may be coupled to one or more rotors 804 with spinning blades 806. By way of non-limiting example, the aircraft structure 800, including the main body 802 coupled to one or more rotors 804 with spinning blades 806, may be a multirotor, such as a quadcopter (e.g., quadrotor), as shown in FIG. 8. Landing gear 812 may also be coupled to the bottom side of the main body 802 of the aircraft structure 800. The aircraft structure 800 may be constructed from light weight material such as polymer materials, (e.g., acrylonitrile butadiene styrene (ABS), polyethylene terephthalate glycol (PETG), polyamides (PA or Nylon), etc.), composite materials (e.g., carbon fiber, fiberglass, a polymer composite materials, etc.) or metals (e.g., aluminum, titanium, etc.). The impurity removal device 801 may be configured to attach to the aircraft structure 800 on the bottom side of the main body 802 of the aircraft structure 800 through a hanger 814. The hanger 814 may be configured to suspend the impurity removal device 801 from the main body 802 of the aircraft structure 800. The impurity removal device 801 may include a top portion 808 and at least two side portions 810. The side portions 810 are securely attached to the top portion 808. The top portion 808 of the impurity removal device 801 may include a mechanism for attaching the impurity removal device 801 to the hanger 814 and/or the main body 802 of the aircraft structure 800. The impurity removal device 801 may include a portion of porous material (not shown) extending between the at least two side portions 810 to allow for adequate airflow through the impurity removal device 801. The impurity removal device 801 of the aircraft structure 800 may include a reacting material (not shown) positioned within the impurity removal device 801, such as between the at least two side portions 810. The reacting material is a material configured to react with impurities, such as CO₂, similar to the reacting material 102 of the impurity removal device 101 described above with reference to FIGS. 1-2B. There may also be more than one impurity removal device 801 attached to the bottom side of the main body 802 of the aircraft structure 800. If there are multiple devices 801 for removing impurities, each impurity removal device 801 may be configured to work on its own, or the devices 801 for removing impurities may be connected in series as explained previously.

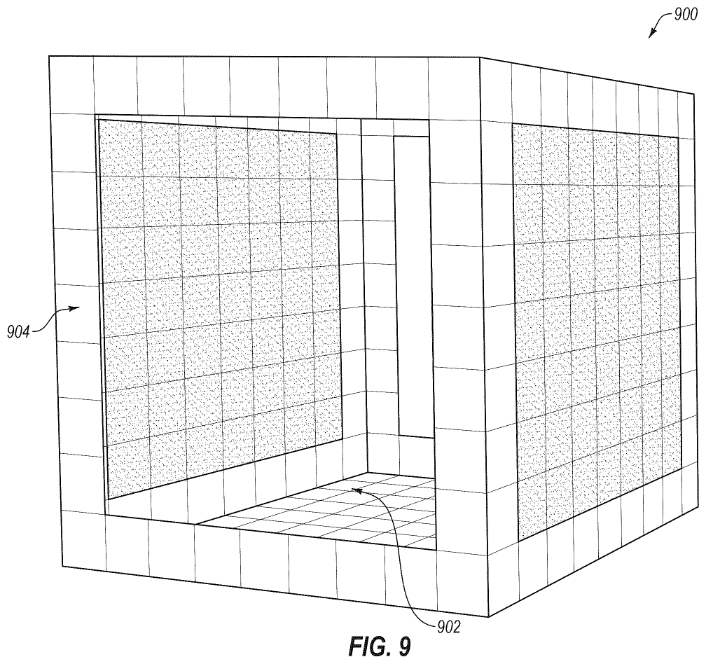

FIG. 9 shows an isometric view of an impurity removal device 900 in accordance with embodiments of the disclosure. The impurity removal device 900 may include a reacting material 902 configured to react with CO₂. The reacting material 902 may include one or more of an amine, a hydroxide, a silicate, an oxide, and other CO₂-absorbing materials. For example, the reacting material 902 may include one or more of sodium hydroxide (NaOH), potassium hydroxide (KOH), lithium hydroxide (LiOH), calcium hydroxide (Ca(OH)₂), calcium oxide (CaO), serpentinite, magnesium silicate hydroxide (Mg₃Si₂O₅(OH)₄), olivine, and others. An exemplary reaction is described above in accordance with equation (1). In some embodiments, the reacting material 902 comprises NaOH. The reacting material 902 may be contained within a compartment 904. The compartment 904 may be a porous shell, such as a porous cellulose shell, a glass microfiber shell, or a polytetrafluoroethylene (PTFE) shell; in addition, the porous shell may be woven, non-woven, or perforated. In this way, the porous shell may be configured to allow air to pass through the compartment 904 while substantially preventing the reacting material 902 from passing through the compartment 904. The compartment 904 may have pore sizes in the range from about 500 nm to about 15 μm, such as from about 1 μm to about 10 μm. The impurity removal device 900 may exhibit a cubic shape, as shown in FIG. 9. In some embodiments, the impurity removal device 900 may exhibit other shapes, such as spherical, triangular, rectangular, cylindrical, and irregular shapes. The impurity removal device 900 may be configured as an attachment or removable cartridge on an aircraft structure (e.g., aircraft structure 100, 300, 800), such that the impurity removal device 900 may be attached and removed or replaced. The size and shape of the impurity removal device 900 may be defined by the size and shape where optimal airflow occurs to promote the reaction between the reacting material 902 and the CO₂ in the atmosphere.

The following examples serve to explain embodiments of the disclosure in more detail. These examples are not to be construed as being exhaustive or exclusive as to the scope of this disclosure.

### EXAMPLES

### Example 1

### Impurity Removal Method:

To start, 30 g of different hydroxides were placed in impingers. Next, a steady flow of 0.5% CO₂, 99.5% nitrogen was passed through the single impinger containing the hydroxide and CO₂ concentration was measured in the outlet gas to determine absorption over time. NaOH showed 75% absorption of CO₂ in the first minute whilst KOH showed 62% absorption of CO₂ in the first minute. No further change in absorption of CO₂ was observed both in case of NaOH and KOH. LiOH absorbed 28% CO₂ and Ca(OH)₂ absorbed 24.5% CO₂ in the first minute. There were minor fluctuations in CO₂ concentration of the outlet gas for three minutes and thereafter it remained constant up to six minutes for both LiOH and Ca(OH)₂.

### Example 2

### Impurity Removal Method:

Two consecutive impingers, each filled with 30 g of NaOH were positioned within a steady flow of air containing CO₂. The outlet from the first impinger was connected as an inlet to the second impinger. 4800 ppm (0.48%) CO₂ gas was used at a flow rate of 1 L/min in the inlet of the first impinger. The outlet gas had only 500 ppm (0.05%) CO₂ indicating 90% reduction after 2-3 seconds of passing through the second impinger. No further reduction or increase of CO₂ concentration was observed in the outlet gas up to six minutes.

### Example 3

### Impurity Removal Method:

The absorption capacity of solid NaOH pellets at higher CO₂ concentrations similar to automobile exhaust and/or factory effluents that have CO₂ compositions in the range of 10-15%, is shown in Table 1. In the case of 5% CO₂, the outlet gas showed 92.5% reduction in CO₂ concentration after one minute and 96% reduction after six minutes. In 10% CO₂, the outlet gas showed 73% reduction in CO₂ concentration after the first minute, but the outlet gas concentration started increasing thereafter. After six minutes, the CO₂ concentration was reduced by 34.2% relative to inlet concentrations. A similar trend was observed with 15% CO₂, with the outlet CO₂ concentration being reduced by 45% after a minute but increasing to a net 12% reduction after six minutes. The impinger was positioned in an ice tray as the impinger temperature increased due to the exothermic nature of the reaction and higher concentration of the reactants.

TABLE 1
CO₂ absorption capacity of solid NaOH pellets at higher
concentrations of CO₂ when placed in an impinger.

| | Concentration of CO₂ in the outlet | | | | | |
|---|---|---|---|---|---|---|
| Concentration of | gas after ‘x’ minutes (%) | | | | | |
| CO₂ in the inlet (%) | 1 | 2 | 3 | 4 | 5 | 6 |
| 5.07 | 0.38 | 0.37 | 0.36 | 0.34 | 0.33 | 0.31 |
| 9.85 | 2.65 | 3.93 | 5.12 | 6.23 | 6.37 | 6.49 |
| 14.87 | 8.25 | 11.56 | 12.80 | 13.52 | 13.75 | 14.02 |

### Example 4

### Impurity Removal Method:

Porous cellulose thimbles and glass microfiber thimbles were used for holding solid NaOH pellets to simulate the use of porous cellulose shells and glass microfiber shells as carriers in the drone attachment. The inlet gas was passed through the thimble and then into two consecutive impingers filled with 30 g of NaOH. Despite the thimble, there was more than 90% reduction of CO₂ in the outlet gas. This reduction was in the same range as double impingers without thimble.

TABLE 2
CO₂ absorption capacity of solid NaOH pellets when placed
in cellulose thimble and glass microfiber thimble.

| Time (min) | 1 | 2 | 3 | 4 | 5 | 6 |
|---|---|---|---|---|---|---|
| % CO₂ in outlet gas when | 0.04 | 0.04 | 0.04 | 0.05 | 0.04 | 0.05 |
| cellulose thimble is used. | | | | | | |
| Concentration of CO₂ in | | | | | | |
| inlet gas was 0.44%. | | | | | | |
| % CO₂ in outlet gas when | 0.03 | 0.03 | 0.03 | 0.04 | 0.04 | 0.03 |
| glass microfiber is used. | | | | | | |
| Concentration of CO₂ in | | | | | | |
| inlet gas was 0.42%. | | | | | | |

The embodiments of the disclosure described above and shown in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

1. An aircraft structure for removal of impurities from the atmosphere comprising:
a fuselage;
one or more wings or rotors extending from the fuselage; and
one or more devices for removing impurities attached to the fuselage, the devices for removing impurities including a reacting material configured to chemically react with the impurities within a compartment configured to enable air to pass through the compartment and to substantially prevent the reacting material from exiting the compartment.

2. The aircraft structure of claim 1, wherein the one or more devices for removing impurities are positioned within the fuselage.

3. The aircraft structure of claim 1, wherein the one or more devices for removing impurities is positioned outside the fuselage.

4. The aircraft structure of claim 1, wherein the compartment comprises a porous material.

5. The aircraft structure of claim 4, wherein the porous material comprises at least one of a porous cellulose shell, a glass microfiber shell, and a polytetrafluoroethylene (PTFE) shell.

6. The aircraft structure of claim 4, wherein the porous material comprises pore sizes in the range from 500 nm to 15 μm.

7. The aircraft structure of claim 1, wherein the reacting material comprises one or more of sodium hydroxide (NaOH), potassium hydroxide (KOH), lithium hydroxide (LiOH), calcium hydroxide (Ca(OH)₂), calcium oxide (CaO), serpentinite, magnesium silicate hydroxide (Mg₃Si₂O₅(OH)₄), and olivine.

8. The aircraft structure of claim 1, wherein the reacting material comprises one or more of a powder, pellets, solid material, impregnated sheet, film, or liquid form.

9. The aircraft structure of claim 1, wherein the more than one devices for removing impurities are connected in series, such that an outlet of a first impurity removal device is connected to an inlet of a next impurity removal device.

10. An aircraft structure for removal of impurities from the atmosphere comprising:
a substantially hollow fuselage comprising a surface defining an internal cavity and a reacting material within the internal cavity configured to react with the impurities;
at least two apertures in the surface configured to enable airflow into the internal cavity through a first aperture and airflow out of the internal cavity through a second aperture;
a porous film positioned between the at least two apertures and the internal cavity; and
at least one wing extending from the substantially hollow fuselage.

11. The aircraft structure of claim 10, wherein the porous film comprises at least one of a porous cellulose shell, a glass microfiber shell, and a polytetrafluoroethylene (PTFE) shell.

12. The aircraft structure of claim 10, wherein the porous film comprises pore sizes in the range from 1 μm to 10 μm.

13. The aircraft structure of claim 10, wherein the reacting material comprises one or more of sodium hydroxide (NaOH), potassium hydroxide (KOH), lithium hydroxide (LiOH), calcium hydroxide (Ca(OH)₂), calcium oxide (CaO), serpentinite, magnesium silicate hydroxide (Mg₃Si₂O₅(OH)₄), and olivine.

14. The aircraft structure of claim 10, wherein the reacting material comprises one or more of a powder, pellets, solid material, impregnated sheet, film, or liquid form.

15. The aircraft structure of claim 10, wherein the first aperture is in the forward most position on the substantially hollow fuselage and the second and a third apertures are longitudinally and radially offset from the first aperture.

16. The aircraft structure of claim 15, wherein the first, second, and third apertures have different sizes and shapes.

17. The aircraft structure of claim 15, wherein the first, second, and third apertures have substantially the same sizes and shapes.

18. A method of removing impurities from the atmosphere comprising:
passing air through a compartment of an aircraft structure, the compartment containing a reacting material configured to react with impurities in the air;
removing impurities from the air by reacting the impurities in the air with the reacting material; and
collecting by-products of the reaction in the compartment of the aircraft structure.

19. The method for removing impurities of claim 18, wherein passing air through the compartment of the aircraft structure, further comprises passing the air through the compartment of the aircraft structure including the reacting material comprising one or more of sodium hydroxide (NaOH), potassium hydroxide (KOH), lithium hydroxide (LiOH), calcium hydroxide (Ca(OH)₂), calcium oxide (CaO), serpentinite, magnesium silicate hydroxide (Mg₃Si₂O₅(OH)₄), and olivine.

20. The method for removing impurities of claim 18, wherein passing air through the compartment of the aircraft structure, further comprises passing the air through the compartment of the aircraft structure including the reacting material comprising one or more of a powder, pellets, solid material, impregnated sheet, film, or liquid form.
